(19) United States
(12) Patent Application Publication
(10) Pub. No.: US 2025/0282589 A1
(43) Pub. Date: Sep. 11, 2025

(54) FORKLIFT TRUCK

(71) Applicant: KABUSHIKI KAISHA TOYOTA JIDOSHOKKI, Kariya-shi (JP)

(72) Inventor: Hirokazu KISHIDA, Kariya-shi (JP)

(73) Assignee: KABUSHIKI KAISHA TOYOTA JIDOSHOKKI, Kariya-shi (JP)

(21) Appl. No.: 19/062,315

(22) Filed: Feb. 25, 2025

(30) Foreign Application Priority Data
Mar. 5, 2024 (JP) 2024-032916

(51) Int. Cl. B66F 9/075; B66F 9/06

(52) U.S. Cl. CPC B66F 9/0755; B66F 9/063

(57) ABSTRACT

A forklift truck includes: a vehicle body; a load handling device; a fork having a load receiving portion for receiving a load and an extending portion extending upward from a proximal end of the load receiving portion; a load detector for detecting the load on the fork; and a controller. The load detector includes: a shaft supported by the fork; an arm configured to come into contact with the load on the fork and swing about the shaft; and an angle detection sensor configured to detect a swing angle of the arm. The controller includes a distance calculation unit. The distance calculation unit is configured to calculate a distance between the load and the extending portion in a longitudinal direction of the load receiving portion based on the swing angle when the load on the fork comes into contact with the arm and the arm swings.

### CROSS-REFERENCE TO RELATED APPLICATION

This application claims priority to Japanese Patent Application No. 2024-032916 filed on Mar. 5, 2024, the entire disclosure of which is incorporated herein by reference.

The present disclosure relates to a forklift truck.

### BACKGROUND ART

A load position detector for a forklift truck is mentioned in Japanese Patent Application Publication No. 2006-193255 as a known technique for a forklift truck, for example. The load position detector mentioned in Japanese Patent Application Publication No. 2006-193255 is provided on a forklift truck, and includes a lever rotatably attached to a fork, a cam rotated with the rotation of the lever pressed by a load on the fork, a switch controlled according to the rotation angle of the cam, and detection means for detecting a position of the load on the fork based on the state of the switch. The switch remains in a first state when the rotation angle of the cam is equal to or less than a first threshold, remains in a second state when the rotation angle of the cam is between the first threshold and a second threshold, and remains in the first state when the rotation angle of the cam is equal to or greater than the second threshold. The detection means detects an abnormality in the position of the load if the switch returns to the first state after transitioning from the first state to the second state.

According to this load position detector, when the load is located at an appropriate position on the fork, the rotation angle of the cam becomes a value between the first threshold and the second threshold, and the switch therefore transitions from the first state to the second state. If the load approaches too close to a chassis of the forklift truck, the rotation angle of the cam becomes greater than the second threshold, and the switch returns from the second state to the first state. The detection means monitors the output of a single switch to detect both that the load is located at an appropriate position on the fork and that the load has approached too close to the chassis. This load position detector is advantageous in that the load position detector prevents the load from coming into contact with the chassis of the forklift truck even with a simple configuration.

However, this load position detector only detects an abnormality in the position of the load on the fork based on the ON state or OFF state of the limit switch. In recent years, there has been a demand for more accurate detection of the position of a load picked up by a fork. In particular, in order to promote unmanned travel of a forklift truck by automated operation, there is a strong demand for accurate detection of the position of the load on the fork in real time.

The present disclosure, which has been made in light of the above-described circumstance, is directed to providing a forklift truck that is capable of accurately detecting a position of a load on a fork.

### SUMMARY

In accordance with an aspect of the present disclosure, there is provided a forklift truck comprising: a vehicle body; a load handling device provided on the vehicle body; a fork provided on the load handling device, the fork having a load receiving portion for receiving a load and an extending portion extending upward from a proximal end of the load receiving portion; a load detector for detecting the load on the fork; and a controller connected to the load detector. The load detector includes: a shaft supported by the fork; an arm configured to come into contact with the load on the fork and swing about the shaft; and an angle detection sensor configured to detect a swing angle of the arm. The controller includes a distance calculation unit. The distance calculation unit is configured to calculate a distance between the load and the extending portion in a longitudinal direction of the load receiving portion based on the swing angle detected by the angle detection sensor when the load on the fork comes into contact with the arm and the arm swings.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a plan view of a forklift truck according to a first embodiment;

FIG. 2 is a side view of the forklift truck according to the first embodiment;

FIG. 3 is a perspective view of the forklift truck according to the first embodiment, illustrating a main part of the forklift truck;

FIG. 4 is a perspective view of a load detector for the forklift truck;

FIG. 5 is a schematic configuration diagram of the forklift truck according to the first embodiment;

FIG. 6 is a side view of a fork, illustrating a position of a load on the fork;

FIG. 7 is a plan view of the fork, illustrating the load being placed at an angle on the fork;

FIG. 8 is a perspective view of a load detector for a forklift truck according to a second embodiment; and

FIG. 9 is a side view of a load detector according to a modified example.

### DETAILED DESCRIPTION OF THE EMBODIMENTS

### First Embodiment

The following will describe a forklift truck according to a first embodiment with reference to the accompanying drawings. The forklift truck according to the first embodiment is capable of unmanned travel by automated operation, and is also capable of manned travel. The forklift truck according to the first embodiment is a reach forklift truck that travels on electric power. The directions explained in the following description are defined with respect to a driver's seat of the forklift truck when an operator sits in the driver's seat and faces the forward direction of the forklift truck.

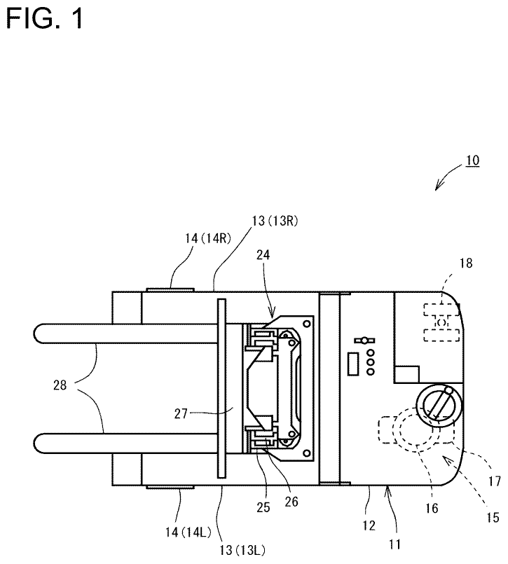

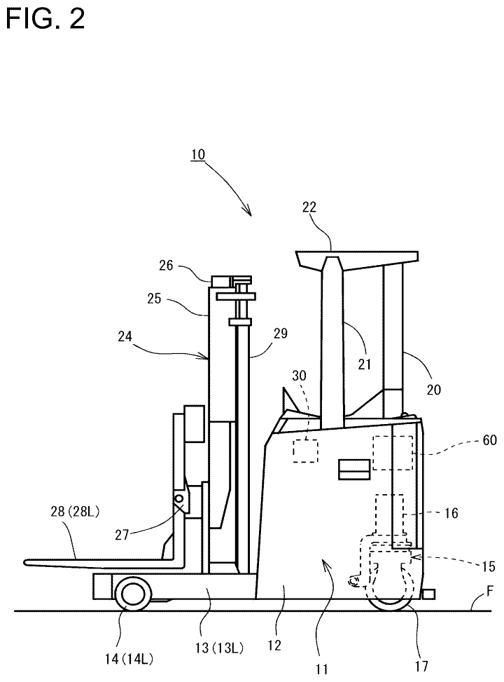

FIG. 1 illustrates a forklift truck 10 including a vehicle body 11. The vehicle body 11 includes a vehicle main body 12, and a right-left pair of reach legs 13 (13R, 13L) extending forward from a front portion of the vehicle main body 12. The reach legs 13 are provided with freely rotatable driven wheels 14, which serve as front wheels. The driven wheels 14 include a driven wheel 14R as a right driven wheel, and a driven wheel 14L as a left driven wheel. FIG. 2 only illustrates the left reach leg 13 (13L) with the left driven wheel 14L.

As illustrated in FIG. 1, the vehicle main body 12 includes a drive unit 15 in the left rear portion of the vehicle main body 12. The drive unit 15 includes a travel motor 16 and a driving wheel 17 serving as a rear wheel. The travel motor 16 drives the driving wheel 17. This causes the forklift truck 10 to travel on a road surface F. The drive unit 15 includes a steering motor (not illustrated) for steering the driving wheel 17. The forklift truck 10 includes a chargeable battery (not illustrated) mounted to the vehicle main body 12. As illustrated in FIG. 1, the forklift truck 10 includes a caster wheel 18 in the right rear portion of the vehicle main body 12. The caster wheel 18 is a freely rotatable wheel for stabilizing the posture of the vehicle body 11.

As illustrated in FIG. 2, the forklift truck 10 includes a right pillar 20 and a left pillar 21 extending upward from the vehicle main body 12. The forklift truck 10 includes a head guard 22 on the right pillar 20 and the left pillar 21. For the sake of explanation, the head guard 22 is not illustrated in FIG. 1.

The forklift truck 10 includes a load handling device 24 provided on the vehicle main body 12. The load handling device 24 is movable relative to the vehicle main body 12 and disposed between the reach legs 13. The load handling device 24 includes: an outer mast 25 supported by the right and left reach legs 13; and an inner mast 26 supported by the outer mast 25 so that the inner mast 26 is movable up and down. The inner mast 26 has a lift support 27 so that the lift support 27 is movable up and down together with the inner mast 26. The lift support 27 supports a right-left pair of forks 28. That is, the forks 28 are provided on the load handling device 24. The upper ends of the forks 28 are supported by the lift support 27 so that the forks 28 tilt. The forks 28 tilt forward and rearward. The forklift truck 10 includes a lift cylinder 29 fixed to the rear of the outer mast 25 for raising and lowering the inner mast 26. The forklift truck 10 includes a control valve 30 mounted to the vehicle main body 12. The control valve 30 is configured to control the supply of hydraulic oil to the lift cylinder 29 of the load handling device 24.

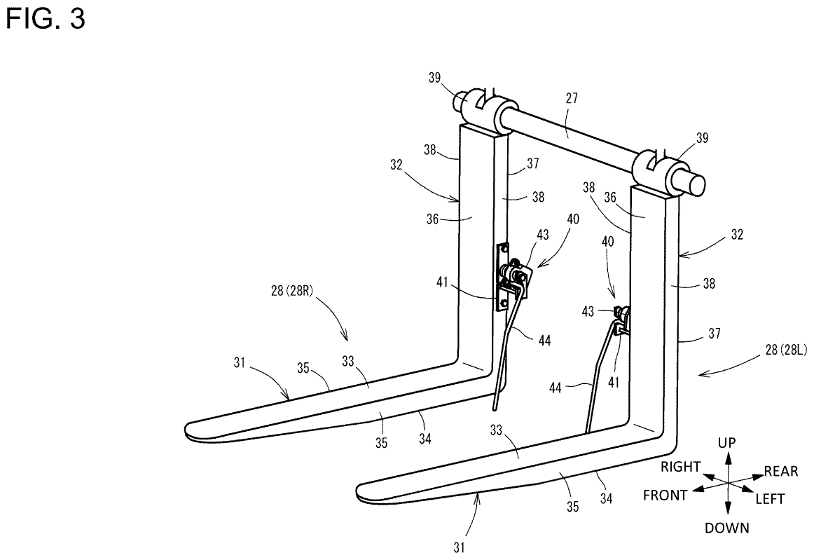

The following will describe the pair of forks 28. The pair of forks 28 includes a right fork 28R and a left fork 28L that have the same configuration, and the following description will focus on the right fork 28R. As illustrated in FIG. 3, the right fork 28R has: a load receiving portion 31 for receiving a load; and an extending portion 32 extending upward from a proximal end of the load receiving portion 31. The load receiving portion 31 extends forward, and has an upper surface 33, a lower surface 34, and a pair of side surfaces 35. The upper surface 33 is a flat surface for receiving a load. The thickness of the load receiving portion 31 decreases from a proximal end (rear end) to a distal end (front end) of the load receiving portion 31. One of the side surfaces 35 faces right and the other of the side surfaces 35 faces the left fork 28L. According to the present embodiment, the longitudinal direction of the load receiving portion 31 corresponds to the front-rear direction of the forklift truck 10.

The extending portion 32 extends upward from the proximal end of the load receiving portion 31. The longitudinal direction of the extending portion 32 is approximately perpendicular to the longitudinal direction of the load receiving portion 31. The extending portion 32 has a front surface 36, a rear surface 37, and a pair of side surfaces 38. The front surface 36 is contactable with the load. The rear surface 37 faces the load handling device 24. One of the side surfaces 38 faces right, and the other of the side surfaces 38 faces the extending portion 32 of the left fork 28L. A support portion 39 having a cylindrical shape is disposed on the extending portion 32, and supported by the lift support 27.

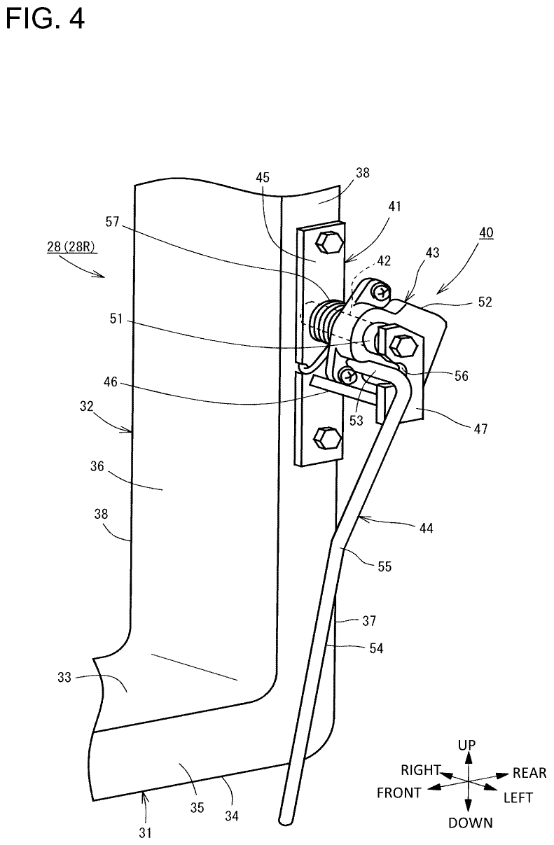

According to the present embodiment, the forklift truck 10 includes a load detector 40 disposed on the other of the side surfaces 38 of the extending portion 32 of the left fork 28L (i.e., the fork 28). As illustrated in FIG. 4, the load detector 40 for detecting the load on the fork includes a bracket 41, a shaft 42, an angle detection sensor 43, and an arm 44. The bracket 41 has a base portion 45 having a plate-like shape and fixed to the side surface 38, a rod portion 46 protruding from the base portion 45 in a direction approximately perpendicular to the side surface 38, and a support portion 47 having a plate-like shape and fixed to the rod portion 46. The shaft 42 is supported by the fork 28 via the base portion 45 and the support portion 47.

The angle detection sensor 43 includes: a fixed part 51 having a cylindrical shape and fixed to the shaft 42; and a movable part 52 that rotates about the shaft 42. The movable part 52 is fixed to the arm 44 so that the arm 44 swings about the shaft 42. The shaft 42 penetrates through the angle detection sensor 43. In the present embodiment, a potentiometer serves as the angle detection sensor 43, and the voltage changes continuously according to the rotation angle of the movable part 52 about the fixed part 51 of the angle detection sensor 43. The angle detection sensor 43 continuously outputs a signal indicating a change in voltage according to the rotation angle of the movable part 52. That is, the angle detection sensor 43 is configured to detect the swing angle of the arm 44.

The arm 44 fixed to the movable part 52 is formed of a metal bar. The arm 44 has a proximal end portion 53 fixed to the movable part 52 of the angle detection sensor 43 and an arm main body 54 extending downward and forward from the proximal end portion 53. The axis of the proximal end portion 53 is approximately parallel to the axis of the shaft 42. The arm 44 is bent so that the arm main body 54 is approximately perpendicular to the proximal end portion 53. The arm main body 54 has a bent portion 55 so that the axial direction of the arm main body 54 is slightly changed.

When the load on the fork 28 comes into contact with the arm 44, the arm 44 swings about the shaft 42. The presence of the bent portion 55 allows the load to approach the extending portion 32 most closely in the longitudinal direction of the load receiving portion 31 when the arm 44 swings the most toward the extending portion 32. The support portion 47 of the bracket 41 has a cutout 56. The presence of the cutout 56 prevents interference between the support portion 47 and the proximal end portion 53 when the arm 44 swings the most toward the extending portion 32. The cutout 56 is formed so as to match the path of the support portion 47 when the arm 44 swings.

The load detector 40 includes a torsion coil spring 57 as an urging member. The torsion coil spring 57 always applies an urging force to the movable part 52 of the angle detection sensor 43 so that the arm 44 moves toward the distal end of the load receiving portion 31 of the fork 28. The shaft 42 is inserted through the center of the torsion coil spring 57. One end of the torsion coil spring 57 is retained in the base portion 45 of the bracket 41, and the other end of the torsion coil spring 57 is retained in the movable part 52 of the angle detection sensor 43. As the arm 44 approaches the extending portion 32, the urging force applied to the movable part 52 increases. The urging force does not displace the load on the fork 28. In the present embodiment, the torsion coil spring 57 serves as the urging member. However, a spring, such as a compression coil spring, may serve as the urging member instead of the torsion coil spring.

The forklift truck 10 includes a controller 60 for controlling devices of the vehicle body 11, and the controller 60 is accommodated in the vehicle main body 12. The controller 60 includes a central processing unit (CPU) as a processing unit, random access memory (RAM) and read-only memory (ROM) as storage units, a communication unit for communicating with the devices of the vehicle body 11 and external devices, and the like. The controller 60 loads a program from the ROM into the RAM. The CPU retrieves instructions from the RAM and executes them to perform the tasks specified by the program. The controller 60 may include a dedicated hardware circuit, such as an application-specific integrated circuit (ASIC), for example. The controller 60 may include at least one processor that is configured to operate by a computer program, at least one dedicated hardware circuit, and a combination of the processor and the dedicated hardware circuit.

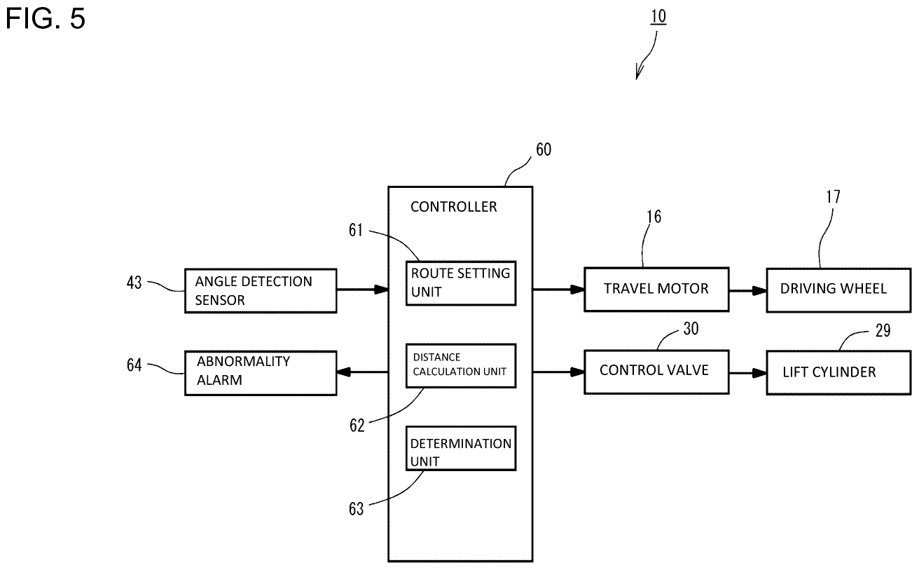

The forklift truck 10 of the present embodiment is capable of unmanned travel by automated operation. Accordingly, the controller 60 includes a route setting unit 61, as illustrated in FIG. 5. The route setting unit 61 is configured to set in advance a travel route along which the forklift truck 10 travels unmanned by automated operation. Specifically, the controller 60 stores a map including travel routes along which the forklift truck 10 may travel unmanned. The controller 60 selects and sets an optimal travel route to the destination of the forklift truck 10 based on conditions, such as a travel distance and travel speed.

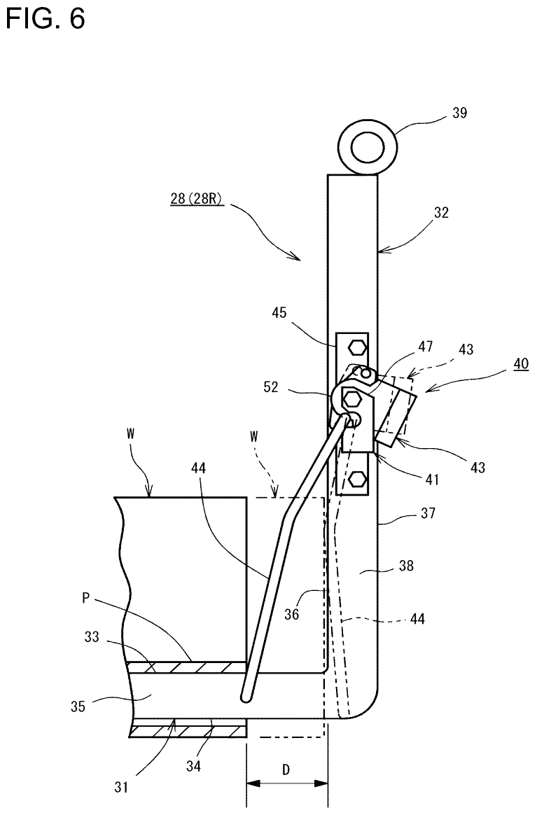

The controller 60 includes a distance calculation unit 62 and a determination unit 63. The controller 60 is connected to the load detector 40. The distance calculation unit 62 is configured to calculate a distance D between the rear surface of a load W on the fork 28 and the front surface 36 of the extending portion 32 in the longitudinal direction of the load receiving portion 31 (see FIG. 6) based on the swing angle of the arm 44 detected by the angle detection sensor 43. Specifically, the distance calculation unit 62 calculates the distance D based on the rotation angle of the movable part 52 of the angle detection sensor 43 about the fixed part 51 by using a trigonometric function. The distance calculation unit 62 calculates the distance D according to the change in the swing angle continuously. As illustrated in FIG. 6, the load W includes a pallet P on which the load is placed. For the sake of explanation, FIG. 6 fragmentary illustrates the pallet P with a fork insertion hole through which the fork 28 is inserted.

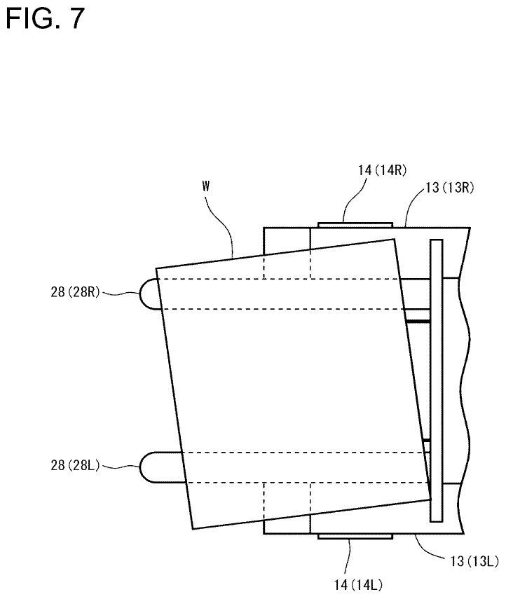

The determination unit 63 is configured to determine whether the condition of the load W on the fork 28 is abnormal. Specifically, the determination unit 63 monitors the calculated distance D, and determines that the condition of the load W is abnormal when the distance D increases over time. For example, as illustrated in FIG. 6, when the load W moves forward from a position indicated by a two-dot chain line to a position indicated by a solid line, the determination unit 63 determines that the condition of the load W is abnormal. In this case, the load W moves toward the distal end of the fork 28, and the load W may fall from the fork 28. Also, the determination unit 63 determines that the condition of the load W is abnormal when the difference between the swing angle detected by the angle detection sensor 43 on the right fork 28R and the swing angle detected by the angle detection sensor 43 on the left fork 28L is equal to or greater than a threshold. In this case, as illustrated in FIG. 7, the load W is excessively inclined with respect to the longitudinal direction (front-rear direction) of the load receiving portion 31 of the forks 28 in a plan view, for example.

As illustrated in FIG. 5, the controller 60 is connected to the travel motor 16, the control valve 30, and an abnormality alarm 64. The abnormality alarm 64 is controlled by the controller 60. The abnormality alarm 64 may include, for example, at least one of a warning buzzer that emits a warning sound to the surroundings and a warning light (for example, a red rotating light or a stack indicator light) that emits a beam of light when the condition of the load W is abnormal. When the determination unit 63 determines that the condition of the load W is abnormal, the controller 60 activates the abnormality alarm 64. The abnormality alarm 64 in the present embodiment serves as the first abnormality alarm and the second abnormality alarm of the present disclosure for indicating that the condition of the load is abnormal. Specifically, the first abnormality alarm indicates an abnormality in the position of the load on the fork 28 when the load moves on the fork 28, and the second abnormality alarm indicates an abnormality in the posture of the load with respect to the fork 28 when the load is inclined with respect to the fork 28.

When the distance D increases over time, the controller 60 decelerates and stops the forklift truck 10. When the difference between the swing angles detected by the right and left angle detection sensors 43 is equal to or greater than the threshold, the controller 60 resets the travel route based on the posture of the load W or controls the load handling device 24 so that the load handling operation is reperformed with the forks 28. The travel route is reset by the route setting unit 61. For example, the route setting unit 61 resets the travel route that causes the forklift truck 10 to travel diagonally according to the inclination of the load W. If the load W is excessively inclined with respect to the longitudinal direction of the load receiving portion 31, the inclination of the load W may not be corrected by resetting the travel route. In this case, the controller 60 controls the control valve 30 so that the lift cylinder 29 operates to reperform the load handling operation in order to correct the excessive inclination of the load W with respect to the longitudinal direction of the load receiving portion 31.

The following will describe the operation of the forklift truck 10 of the present embodiment. The forklift truck 10 travels unmanned by automated operation and performs loading and unloading operations of the load W. The route setting unit 61 sets in advance an optimal travel route to the destination along which the forklift truck 10 travels unmanned by automated operation. When the fork 28 is inserted into the pallet P to pick up the load W including the pallet P, the arm 44 of the load detector 40 comes into contact with the rear surface of the load W. When the fork 28 is inserted deeply into the pallet P, the arm 44 is pressed against the load W and displaced rearward against the urging force of the torsion coil spring 57, and the movable part 52 of the angle detection sensor 43 rotates about the fixed part 51.

The movable part 52 rotates about the fixed part 51, so that the voltage changes according to the rotation angle of the movable part 52. The angle detection sensor 43 continuously outputs a signal indicating a change in the voltage. Upon receiving a signal from the angle detection sensor 43, the distance calculation unit 62 of the controller 60 calculates the distance D between the rear surface of the load W and the front surface 36 of the extending portion 32 based on the rotation angle of the movable part 52. That is, the distance calculation unit 62 calculates the distance D continuously based on the displacement of the arm 44 (i.e., the swing angle of the arm 44). As the load W approaches the front surface 36 of the extending portion 32, the swing angle of the arm 44 increases and the distance D decreases. When the displacement of the arm 44 (i.e., the swing angle of the arm 44) is maximum, the distance D is 0.

The angle detection sensor 43 is provided on each of the right fork 28R and the left fork 28L. Each angle detection sensor 43 detects the swing angle of the corresponding arm 44. The distance calculation unit 62 calculates the distance D between the rear surface of the load W and the front surface 36 of the extending portion 32 of the right fork 28R and the distance D between the rear surface of the load W and the front surface 36 of the extending portion 32 of the left fork 28L.

The distance calculation unit 62 of the controller 60 calculates the distance D continuously based on the displacement of the arm 44. The determination unit 63 determines whether the condition of the load W is abnormal. The determination unit 63 monitors the calculated distance D, and determines that the condition of the load W is abnormal when the distance D increases over time. When the determination unit 63 determines that the condition of the load W is abnormal, the controller 60 activates the abnormality alarm 64 and controls the travel motor 16 so that the forklift truck 10 decelerates and stops.

Also, the determination unit 63 determines that the condition of the load W is abnormal when the difference between the swing angle detected by the angle detection sensor 43 on the right fork 28R and the swing angle detected by the angle detection sensor 43 on the left fork 28L is equal to or greater than the threshold. In this case, the load W is excessively inclined with respect to the longitudinal direction of the load receiving portion 31 of the forks 28 in a plan view, and the controller 60 activates the abnormality alarm 64. When the difference between the swing angles detected by the right and left angle detection sensors 43 is equal to or greater than the threshold, the controller 60 resets the travel route based on the posture of the load W or controls the load handling device 24 so that the load handling operation is reperformed with the forks 28.

The travel route is reset by the route setting unit 61. For example, the route setting unit 61 resets the travel route that causes the forklift truck 10 to travel diagonally according to the inclination of the load W (see FIG. 7). If the load W is excessively inclined, the inclination of the load W may not be corrected by resetting the travel route. In this case, the controller 60 controls the load handling device 24 so that the load handling operation is reperformed with the forks 28. After the travel route is reset or the load handling operation is reperformed, the controller 60 stops the abnormality alarm 64. When the determination unit 63 determines that the condition of the load W is not abnormal, the forklift truck 10 continues to travel unmanned by automated operation.

The forklift truck 10 of the present embodiment achieves the following advantages effects.

(1) When the load W on the fork 28 comes into contact with the arm 44, the arm 44 swings about the shaft 42. When the arm 44 swings, the swing angle of the arm 44 is detected by the angle detection sensor 43. The distance calculation unit 62 of the controller 60 calculates the distance D between the load W on the load receiving portion 31 and the extending portion 32 based on the swing angle of the arm 44 detected by the angle detection sensor 43. This allows the controller 60 to accurately determine the position of the load W on the fork 28. For example, if the shape of the fork insertion hole varies depending on the type of pallet, the controller 60 accurately determines the position of the load W on the fork 28, which ensures high robustness.

(2) The angle detection sensor 43 detects the swing angle of the arm 44 continuously. This allows the controller 60 to determine the position of the load W on the fork 28 continuously.

(3) The forklift truck 10 includes the abnormality alarm 64 for indicating that the condition of the load W on the fork 28 is abnormal. When the load W moves toward the distal end of the load receiving portion 31, the controller 60 activates the abnormality alarm 64. When the load W moves toward the distal end of the load receiving portion 31 during travel or loading, the swing angle of the arm 44 detected by the angle detection sensor 43 decreases. The controller 60 activates the abnormality alarm 64 when the load W moves toward the distal end of the load receiving portion 31. Accordingly, an abnormality in the position of the load W on the fork 28 is detectable.

(4) When the difference between the swing angle detected by the angle detection sensor 43 (i.e., one of the angle detection sensors 43) on the right fork 28R and the swing angle detected by the angle detection sensor 43 (i.e., the other of the angle detection sensors 43) on the left fork 28L is equal to or greater than the threshold, the controller 60 determines that the load W is excessively inclined with respect to an insertion direction of the fork 28, and activates the abnormality alarm 64. Accordingly, an abnormality in the posture of the load W on the fork 28 is detectable.

(5) The controller 60 includes the route setting unit 61 configured to set in advance a travel route along which the forklift truck 10 travels. When the abnormality alarm 64 is activated, the controller 60 resets the travel route based on the posture of the load W, or controls the load handling device 24 so that the load handling operation is reperformed with the forks 28. This eliminates the need to stop the forklift truck 10.

(6) The forklift truck 10 is capable of unmanned travel by automated operation. That is, the forklift truck according to the present embodiment is capable of travelling unmanned and accurately determining the position of the load W on the forks 28.

### Second Embodiment

The following will describe a forklift truck according to a second embodiment. In the second embodiment, the configuration of the arm is different from that of the first embodiment. In the following description, elements identical to those in the first embodiment are denoted by the same reference numerals, and a detailed description of elements and configuration identical to those in the first embodiment is omitted.

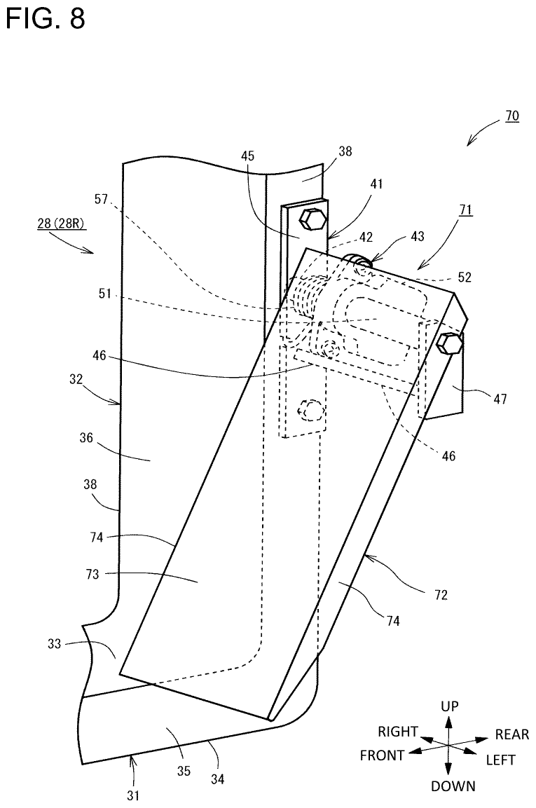

As illustrated in FIG. 8, a forklift truck 70 according to the second embodiment includes a load detector 71 disposed on the side surface 38 of the right fork 28R. The load detector 71 for detecting the load on the fork includes the bracket 41, the shaft 42, the angle detection sensor 43, the torsion coil spring 57, and an arm 72. The arm 72 is formed by bending a metal plate. The arm 72 has a flat plate portion 73 that is contactable with the load W, and a pair of side plate portions 74 that are bent portions of the metal plate extending from the both side ends of the flat plate portion 73. The arm 72 is fixed to the movable part 52 of the angle detection sensor 43. That is, the arm 72 is supported so that the arm 72 swings about the shaft 42. In the present embodiment, the lengths of the fixed part 51 and the rod portion 46 correspond to the width of the flat plate portion 73 of the arm 72.

The front surface of the flat plate portion 73 of the arm 72 is substantially flush with the front surface 36 of the extending portion 32 when the displacement of the arm 72 (i.e., the swing angle of the arm 72) is maximum. Although not illustrated, the left fork 28L also has the load detector 71.

The present embodiment achieves the same advantageous effects as those of the first embodiment. Furthermore, the arm 72 according to the second embodiment is formed of a metal plate, and therefore is less prone to deformation and has superior durability compared to the rod-shaped arm 44 according to the first embodiment.

The present disclosure is not limited to the above-described embodiments, and various modifications are possible within the scope of the disclosure. For example, the forklift truck of the present disclosure may be modified as follows.

In the embodiments, each of the forks is provided with the load detector, but not limited thereto. Only one of the forks may be provided with the load detector.

In the embodiments, the angle detection sensor detects the swing angle of the arm continuously, but not limited thereto. The angle detection sensor may detect the swing angle stepwise.

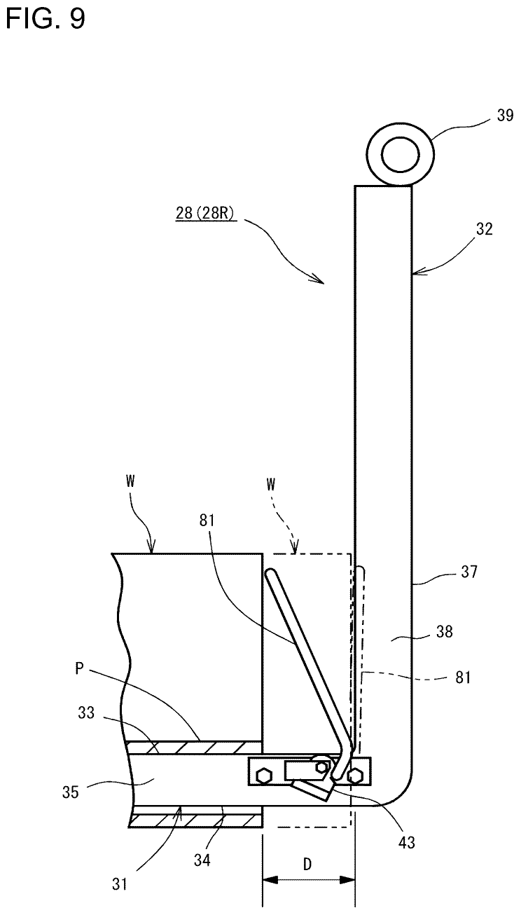

In the embodiments, the angle detection sensor is disposed on the extending portion of the fork, but not limited thereto. As illustrated in FIG. 9, the angle detection sensor 43 may be disposed, for example, on the side surface 35 of the load receiving portion 31 of the fork 28. In this configuration, the load detector includes an arm 81 on the movable part 52 of the angle detection sensor 43, and the arm 81 extends upward and forward from the side surface 35 of the load receiving portion 31. This configuration allows the angle detection sensor to be disposed on the fork, even when it is not possible to dispose the angle detection sensor on the extending portion of the fork.

In the embodiments, the forklift truck includes the abnormality alarm, but not limited thereto. For example, the forklift truck does not necessarily have to include the abnormality alarm. Regardless of whether the forklift truck includes the abnormality alarm, when the determination unit determines that the load has moved toward the distal end of the load receiving portion of the fork, the forklift truck decelerates and stops. When the determination unit determines that the load has been inclined with respect to the longitudinal direction of the load receiving portion of the fork, the travel route is reset or the load handling operation is reperformed.

In the above embodiment, the abnormality alarm 64 serves as both the first abnormality alarm and the second abnormality alarm, but not limited thereto. For example, the forklift truck may include abnormality alarms, i.e., a first abnormality alarm for indicating an abnormality in the position of the load when the load moves on the fork and a second abnormality alarm for indicating an abnormality in the posture of the load when the load is inclined with respect to the load receiving portion. In this configuration, an abnormality in the position of the load and an abnormality in the posture of the load may be detected by a single angle detection sensor.

What is claimed is:

1. A forklift truck comprising:
a vehicle body;
a load handling device provided on the vehicle body;
a fork provided on the load handling device, the fork having a load receiving portion for receiving a load and an extending portion extending upward from a proximal end of the load receiving portion;
a load detector for detecting the load on the fork; and
a controller connected to the load detector, wherein
the load detector includes:
a shaft supported by the fork;
an arm configured to come into contact with the load on the fork and swing about the shaft; and
an angle detection sensor configured to detect a swing angle of the arm, and
the controller includes a distance calculation unit, the distance calculation unit being configured to calculate a distance between the load and the extending portion in a longitudinal direction of the load receiving portion based on the swing angle detected by the angle detection sensor when the load on the fork comes into contact with the arm and the arm swings.

2. The forklift truck according to claim 1, wherein
the angle detection sensor detects the swing angle of the arm continuously or stepwise.

3. The forklift truck according to claim 1, wherein
the forklift truck includes a first abnormality alarm for indicating that a condition of the load is abnormal, and
the controller activates the first abnormality alarm when the load moves toward a distal end of the load receiving portion.

4. The forklift truck according to claim 1, wherein
the forklift truck includes a second abnormality alarm for indicating that a condition of the load is abnormal,
the fork includes a pair of forks,
the angle detection sensor includes a pair of angle detection sensors,
the forks are provided with the angle detection sensors, respectively, and
the controller activates the second abnormality alarm when a difference between the swing angle detected by one of the angle detection sensors and the swing angle detected by the other of the angle detection sensors is equal to or greater than a threshold.

5. The forklift truck according to claim 4, wherein
the controller includes a route setting unit configured to set in advance an optimal travel route to a destination, and
when the second abnormality alarm is activated, the controller resets the travel route based on a posture of the load, or controls the load handling device so that load handling operation is reperformed with the forks.

6. The forklift truck according to claim 3, wherein the forklift truck is capable of travelling unmanned by automated operation.

7. The forklift truck according to claim 5, wherein the forklift truck is capable of travelling unmanned by automated operation.
